(19) United States
(12) Patent Application Publication
(10) Pub. No.: US 2013/0042821 A1
(43) Pub. Date: Feb. 21, 2013

(54) SILICONE PET IDENTIFICATION COLLAR

(71) Applicants: Michele Rebecca Roberts, Provo, UT (US); Carilee Bringhurst, West Jordan, UT (US); Tiffany Jean Reed, Springville, UT (US)

(72) Inventors: Michele Rebecca Roberts, Provo, UT (US); Carilee Bringhurst, West Jordan, UT (US); Tiffany Jean Reed, Springville, UT (US)

(73) Assignee: KIND KOLLARS, LLC, Provo, UT (US)

(21) Appl. No.: 13/372,370

(22) Filed: Feb. 13, 2012

Related U.S. Application Data
(60) Provisional application No. 61/442,094, filed on Feb. 11, 2011.

(51) Int. Cl. A01K 27/00

(52) U.S. Cl. 119/863

(57) ABSTRACT

Embodiments of an invention described herein relate to a silicone band for use as a pet collar. In one embodiment, the pet collar includes a silicone band. The collar includes a snap at a first end of the silicone band. The collar also includes a plurality of snap receivers at a second end of the silicone band.

### CROSS-REFERENCE TO RELATED APPLICATIONS

This application claims the benefit of priority of U.S. Provisional Patent Application 61/442,094, entitled “Silicon Pet Identification Collar” which was filed Feb. 11, 2011, the content of which is incorporated herein in its entirety.

### BACKGROUND

There are many types of conventional pet collars. While many conventional pet collars are made of material that is considered durable, such pet collars can also suffer from disadvantages. Many conventional pet collars are relatively heavy and/or noisy, which results annoyance to the pets. Many conventional pet collars are made of material that can be irritating to a pet's skin when worn at the correct size to prevent removal. Alternatively, if a pet collar is too loose, then some pets may be able to remove and lose the pet collar. Additionally, a pet collar that is too loosely worn can be a choking hazard for the pet. Also, many conventional pet collars have a limited size range and/or adjustability.

### SUMMARY

Embodiments of an invention described herein relate to a silicone band for use as a pet collar. In one embodiment, the pet collar includes a silicone band. The collar also includes a snap at a first end of the silicone band. The collar also includes a plurality of snap receivers at a second end of the silicone band.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a pet collar in a closed position.

FIG. 2 depicts a schematic diagram of one embodiment of a pet collar in an open position.

FIG. 3 depicts a schematic diagram of one embodiment of multiple pet collars joined to form a larger pet collar.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention.

Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments include a pet identification collar. In this description, references to a pet identification collar or pet collar may refer to any collar or bracelet with similar characteristics. Moreover, although embodiments are described herein as a collar made primarily of silicone, the collar also may be made of other materials, such as rubber, plastic, metal, mesh, leather or other material capable of performing similar functions of a collar. In some embodiments, silicone is a primary material for fabrication of the pet collar, and other materials are used in combination with the silicone.

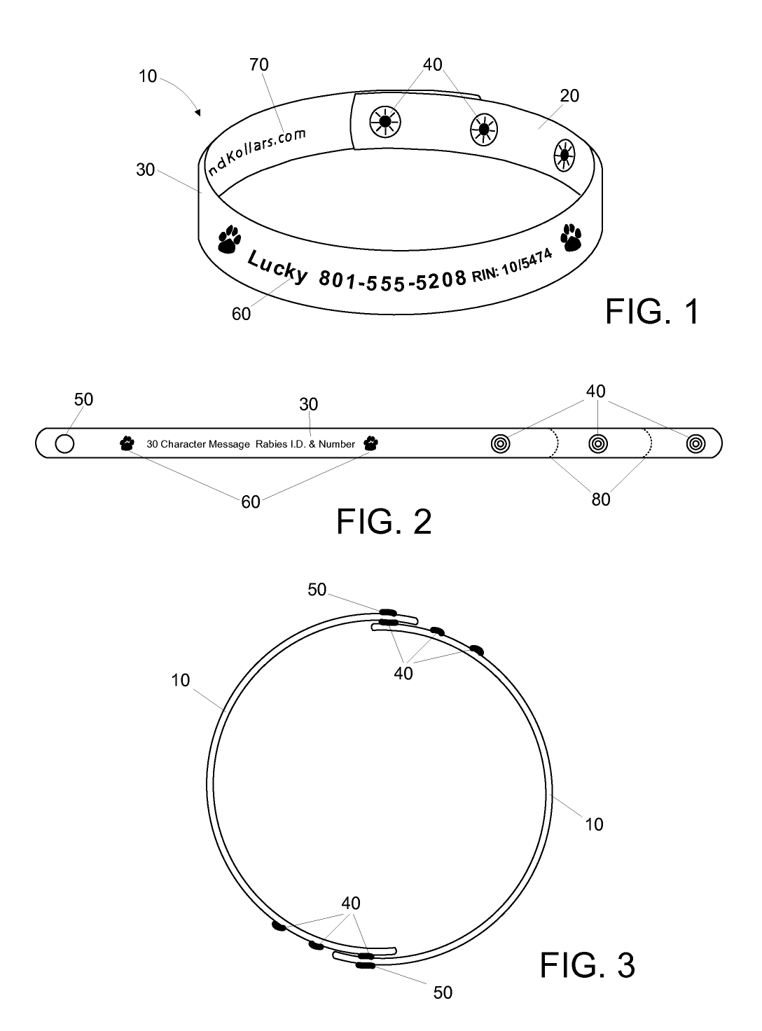

FIG. 1 illustrates one embodiment of a silicone pet collar 10 in a closed position. The pet collar 10 includes an inner surface 20 made primarily of silicone, which may include an interior etch and/or print 70 for identification, decorative, advertising or other purposes. The pet collar 10 also includes an outer surface 30 which may include a paint layer or other material coating a surface of the collar 10. The outer surface 30 may include an exterior print 60 with information related to the pet or animal that is using the pet collar 10. The writing may be, for example, laser-etched writing or artwork engraved onto the surface of the silicone layer. The inner or outer surfaces 20, 30 may also include a paint layer of a different color than the silicone. Writing or other artwork may be etched through the paint layer, exposing the color of the silicone layer and displaying the writing or artwork. The color configuration of the silicone and the paint layer may be a combination of any colors, allowing for variety in the design of the collar 10. While the interior and exterior prints 70, 60 may be decorative, the interior and exterior prints 70, 60 may also replace the identification and licensing functions of a license or tag used with conventional pet collars by identifying relevant information of the pet and/or owner.

FIG. 1 also illustrates a pet collar 10 with a plurality of snap receivers 40 connecting together two ends of the pet collar 10 thereby securing the pet collar 10 around the neck, leg, arm, or waist of an animal. As illustrated, the collar 10 includes several snap receivers 40, allowing the pet collar 10 to be used on a variety of animals of different shapes and sizes, increasing its general utility as well as allowing owners to purchase a single collar 10 for a portion or duration of a pet's life and conveniently adjust the collar size as the pet grows. The snap receivers 40 may also be configured to break or unsnap at a certain threshold of pressure or force on the collar due to pulling or tugging on the collar 10. This feature would provide a safety mechanism for when a collar gets stuck or caught onto an object and preventing the animal from choking.

Additionally, while different materials may be used, at least one embodiment of the collar 10 is made primarily of silicone. Use of silicone allows for inexpensive construction of the collar 10 as well as making the collar 10 lightweight and durable, reducing irritation caused by physical interaction of the collar with the skin or fur of the pet. Also, in addition to being durable and lightweight, the silicone collar 10 may be waterproof and resistant to different forms of wear and tear. Other conventional collars made of other materials, for example, leather and metal, may wear out or otherwise degrade from surrounding conditions, such as varying temperatures, exposure to moisture, or other factors.

FIG. 2 illustrates a top view of a silicone pet collar 10 in an open position. The pet collar 10 includes a snap 50 at a first distal end of the pet collar 10. The illustrated embodiment also includes a plurality of snap receivers 40 located at a second distal end of the pet collar 10. As illustrated in FIG. 1, the snap 50 and the snap receivers 40 may be configured to snap together and bring the collar 10 into a closed loop. The snap 50 and snap receivers 40 may be made from a variety of materials, including plastic, metal, or other durable material. Additionally, the collar may include any number of snap receivers 40 beyond the illustrated example, which may be spaced apart at various locations along the collar 10. In one example, the snap receivers 40 are spaced approximately 2.5 inches apart and located approximately 9, 11.5, and 14 inches from the snap 50. Additionally, while the silicone pet collar 10 may only extend to a certain length, the snaps 50 and snap receivers 40 may also be attached to snaps 50 or snap receivers 40 of additional collars 10, thereby allowing multiple collars 10 to be attached together and be jointly used as a larger collar 10.

FIG. 2 also illustrates an outer surface 30 which may include a paint layer or other material coating the surface of the silicone. The outer surface 30 may include an exterior print 60 with information related to the pet or animal that is using the pet collar 10. In the illustrated figure, the exterior print 60 shows a space for a custom message with a rabies I.D. and number of the pet. This exterior print 60 may include any information, pattern, artwork, or picture that a designer, owner or manufacturer chooses.

FIG. 2 also illustrates a plurality of grooves 80 between the snap receivers 40. While the collar 10 is designed to function on a variety of different animals of different shapes and sizes, many pets may never utilize all of the snap receivers 40 or the full length of the collar 10. The grooves 80 provide points at which the collar 10 may be cut for shortening the length of the collar 10 while still maintaining a rounded or smooth edge of the collar 10.

In a further embodiment, multiple collars 10 may be linked together to form a larger collar. FIG. 3 illustrates one embodiment of two collars 10 that are snapped together in order to form a collar with a larger circumference. For each individual collar 10, the snap 50 is coupled to one of the snap receivers 40 of the other collar 10. By selecting one of the various snap receivers 40, different combinations overall lengths may be realized.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A pet collar comprising:
a silicone band;
a snap at a first end of the silicone band; and
a plurality of snap receivers located at a second end of the silicone band, the plurality of snap receivers spaced approximately 1.5 to 3.5 inches apart on the silicone band.

2. The silicone pet collar of claim 1, wherein the plurality of snap receivers are spaced approximately 2.0 to 3.0 inches apart on the silicone band.

3. The silicone pet collar of claim 1, wherein the plurality of snap receivers are spaced approximately 2.5 inches apart on the silicone band.

4. The silicone pet collar of claim 1, wherein the plurality of snap receivers comprise at least three snap receivers.

5. The silicone pet collar of claim 1, further comprising a cut marking on at least one surface of the silicone band, wherein the cut marking is indicative of a location at which the silicone band is trimmed to a corresponding length.

6. The silicone pet collar of claim 1, wherein the cut marking is disposed between a pair of the snap receivers.

7. The silicone pet collar of claim 1, at least one cut marking disposed between each pair of the snap receivers.

8. The silicone pet collar of claim 1, further comprising an exterior print, the exterior print being etched onto the surface of the silicone band.

9. The silicone pet collar of claim 8, wherein the exterior print is laser-etched onto the surface of the silicone band.

10. The silicone pet collar of claim 1, further comprising an interior print on an inner surface of the silicone band.

11. The silicone pet collar of claim 1, wherein the plurality of snap receivers comprise:
a first snap receiver located approximately 9 inches from the snap at the first end of the silicone band;
a second snap receiver located approximately 11.5 inches from the snap at the first end of the silicone band; and
a third snap receiver located approximately 14 inches from the snap at the first end of the silicone band.
